(19) United States
(12) Patent Application Publication
(10) Pub. No.: US 2013/0332476 A1
(43) Pub. Date: Dec. 12, 2013

(54) VECTOR ROAD NETWORK SIMPLIFICATION

(71) Applicant: APPLE INC., Cupertino, CA (US)

(72) Inventors: Pinaki Sinha, Los Altos, CA (US); Denis Laprise, Saratoga, CA (US)

(73) Assignee: APPLE INC., Cupertino, CA (US)

(21) Appl. No.: 13/669,291

(22) Filed: Nov. 5, 2012

Related U.S. Application Data
(60) Provisional application No. 61/657,711, filed on Jun. 8, 2012.

(51) Int. Cl. G06F 17/30

(52) U.S. Cl. 707/756; 707/E17.009

(57) ABSTRACT

Apparatus and method for simplifying vector road network data. For example, a method in accordance with one embodiment comprises: receiving input data comprising a vector road network specifying vertices and edges; removing discontinuities in paths defined by the vertices and edges; chaining adjacent edges, the chain reducing the number of vertices and producing a set of paths; merging spatially proximal paths to create a set of merged paths; and determining a set of reduced paths from the set of merged paths.

### CLAIM TO PRIORITY

This application claims priority to U.S. Provisional Patent Application No. 61/657,711, filed on Jun. 8, 2012, entitled, “Vector Road Network Simplification which is hereby incorporated by reference in its entirety into this application.

### BACKGROUND

1. Field of the Invention

This invention relates generally to the field of data processing systems. More particularly, the invention relates to an improved system and method for simplifying vector road network data.

2. Description of Related Art

The present invention relates to the field of digital maps, and in particular to digital maps which are created and displayed from vector data representing a road network.

Prior digital map systems, such as Google Maps, rely upon images to present roads on a map. Unlike Google Maps, vector maps on clients offer many advantages described further below.

### SUMMARY

An apparatus and method are described for simplifying vector road network data. For example, a method in accordance with one embodiment comprises: receiving input data comprising a vector road network specifying vertices and edges; removing discontinuities in paths defined by the vertices and edges; chaining adjacent edges, the chain reducing the number of vertices and producing a set of paths; merging spatially proximal paths to create a set of merged paths; and determining a set of reduced paths from the set of merged paths.

### BRIEF DESCRIPTION OF THE DRAWINGS

A better understanding of the present invention can be obtained from the following detailed description in conjunction with the following drawings, in which:

FIGS. 1(a)-(b) illustrate how discontinuities are removed in accordance with one embodiment of the invention.

FIG. 2 illustrates a road network with many discontinuities which are not perceivable at the selected zoom level.

FIG. 3 illustrates the road network with discontinuities removed.

FIGS. 4(a)-(b) illustrates a set of freeways before and after paths are merged in accordance with one embodiment of the invention.

FIGS. 5-6 illustrate a map of San Francisco before and after techniques employed by the embodiments of the invention are implemented.

FIGS. 7-8(f) illustrate methods in accordance with different embodiments of the invention.

FIG. 9 illustrates an exemplary data processing system on which the embodiments of the invention may be implemented.

FIG. 10 illustrates an exemplary application programming interface (API) architecture on which the embodiments of the invention may be executed.

FIG. 11 illustrates an exemplary service-based architecture on which the embodiments of the invention may be executed.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

An embodiment of the present invention can utilize a server data processing system to process input data to create a simplified vector road network which can provide for efficient loading and rendering on client devices, such as one or more smartphones which can connect to a distribution or transmission server which transmits compressed tiles which are stitched together to present one or more maps at the client devices.

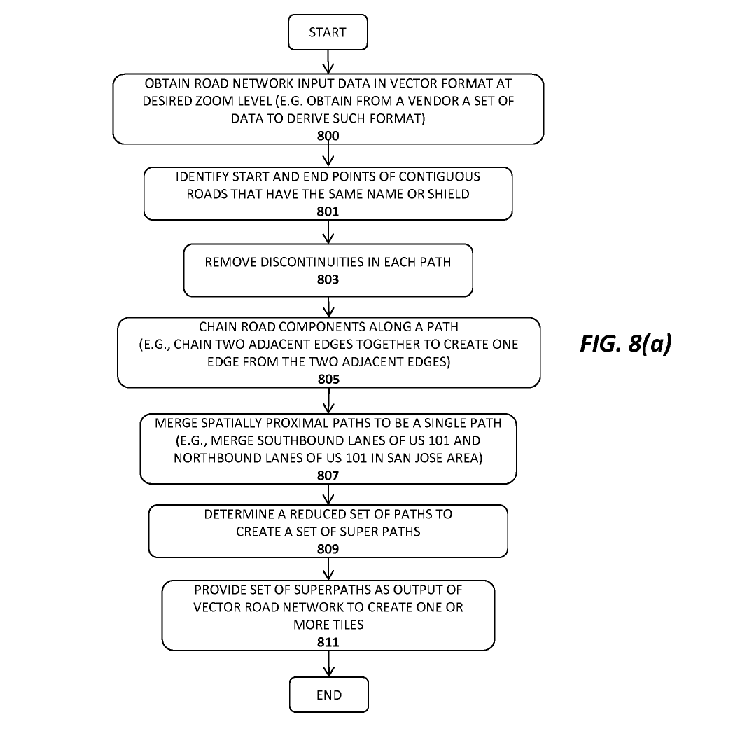

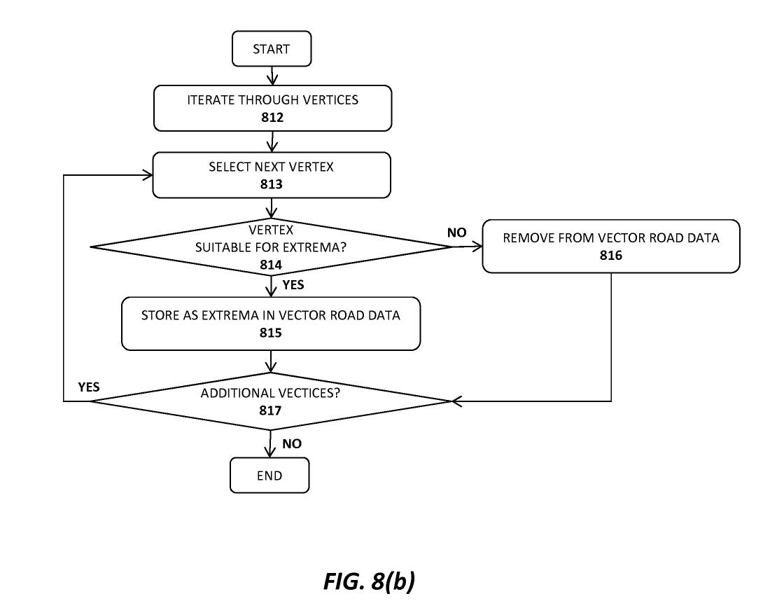

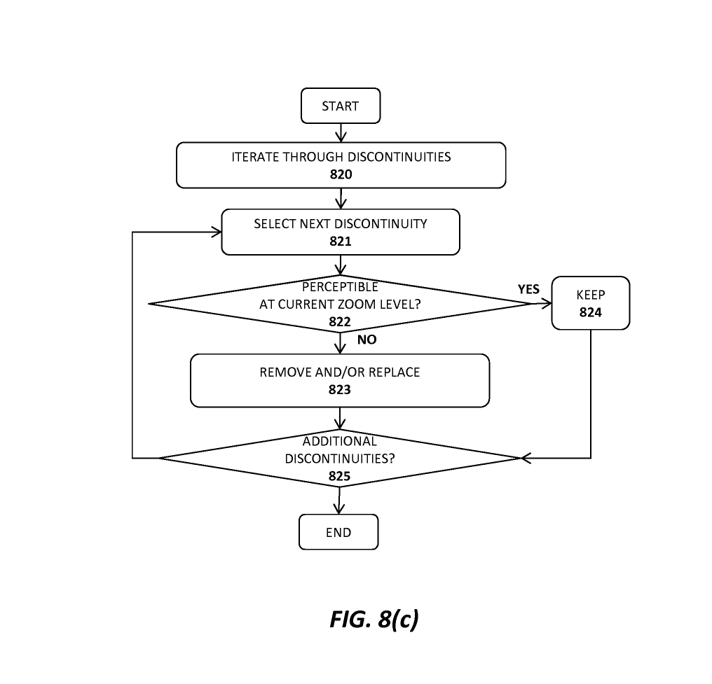

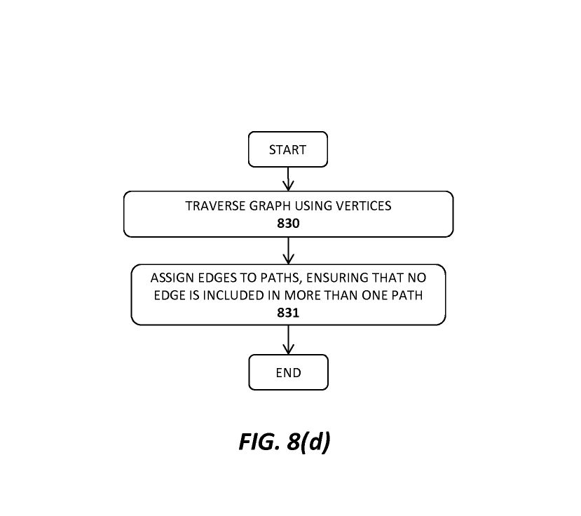

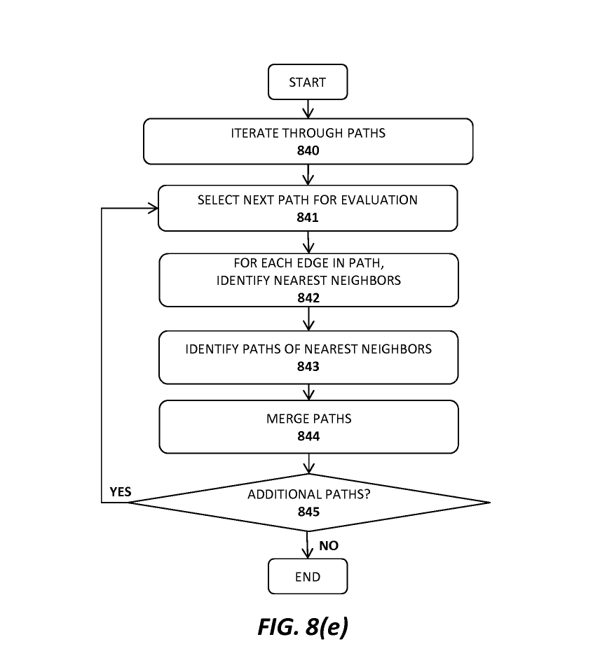

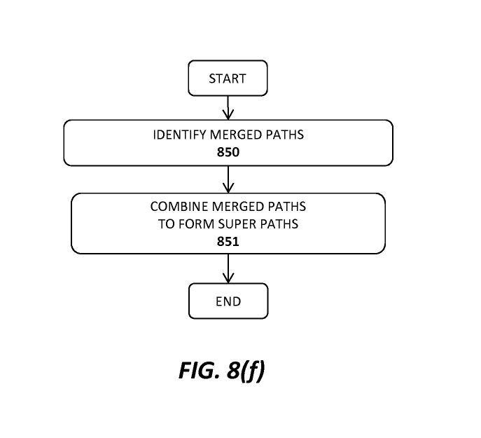

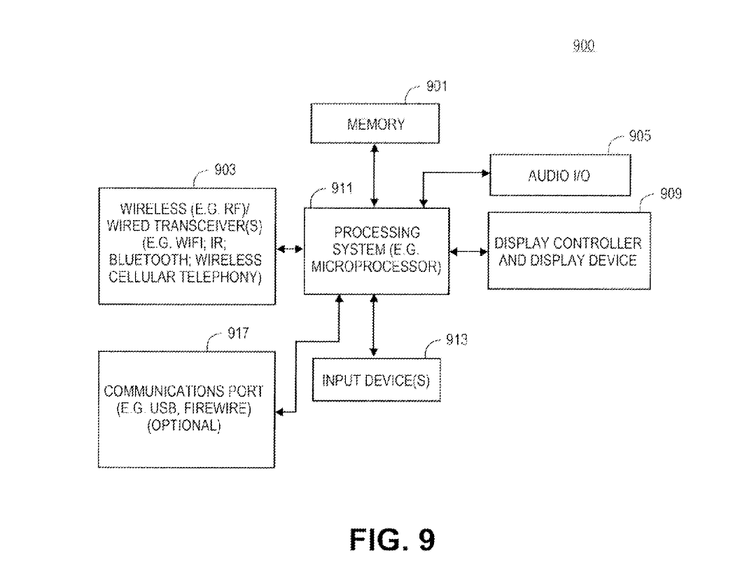

FIG. 9 shows an example of a data processing system which can be a server and/or client system which performs one or more of the methods described herein, such as the methods in FIG. 8(a) which will be described further below. In one embodiment, each of a set of algorithms, identified below as Algorithms 1 through 5, can be performed at a given zoom level to prepare and generate a vector road network which can then be included as part of a set of vector road network “tiles.” The tiles may be rendered on a client device after the client device receives the one or more tiles from the server. In one embodiment, the maps provided to a client device can use road network data that is entirely based on vector data (i.e., containing no images as in prior mapping systems).

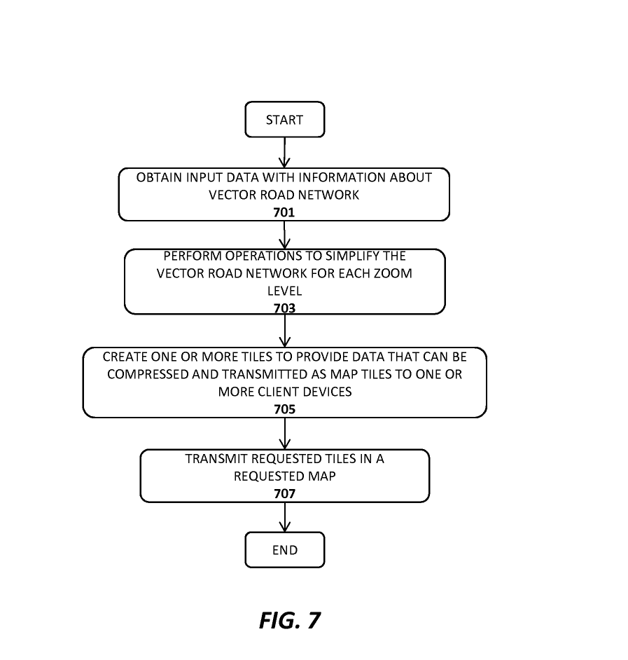

FIG. 7 shows an example of an overview of the method according to one embodiment of the present invention. In operation 701, input data is received with information about a vector road network. In one embodiment, a vector road network data can be obtained from a vendor who sells or otherwise provides such vector data. In operation 703, one or more of the five algorithms can be performed as operations to simplify the vector road network for each zoom level. The operations in Algorithms 1 through 5 can be performed at each desired zoom level, wherein each zoom level is processed independently of the other zoom levels and separately from the other zoom levels to achieve simplified vector road networks for each zoom level. In operation 705, one or more tiles are created to provide data that can be transmitted, usually in a compressed format, as map tiles to one or more client devices. In operation 707, the same server system or a set of transmission server systems can transmit the requested tiles in a requested map in response to a request from a client device.

FIG. 8(a) is a flowchart which illustrates a method according to one embodiment of the present invention which employs the five algorithms (described further below). After obtaining the input data in operation 800, operation 801 identifies the start and end points of contiguous roads that have the same name or shield; in one embodiment, Algorithm 1 described below can be used to perform operation 801. In operation 803, the discontinuities in each path can be removed according to one embodiment using Algorithm 2 described below. Then, in operation 805, road components, such as different edges along the path can be chained together such that two adjacent edges along a path are combined together to create one edge from the two adjacent edges. This can reduce the number of vertices and edges and can be implemented using Algorithm 3 below. In operation 807, a data processing system can merge spatially proximal paths to be a single path. For example, the data processing system can merge the southbound lanes of U.S. 101 and the northbound lanes of U.S. 101 in the San Jose area to create a single path. In one embodiment, Algorithm 4 described below can be used to perform operation 807. Then, in operation 809, a data processing system determines a reduced set of paths to create a set of “super paths;” in one embodiment Algorithm 5 described below can be used to perform operation 809. In operation 811, a set of super paths created in operation 809 can be provided as an output for the vector road network which is simplified relative to the input data in operation 800, and this simplified vector road network can be used to create one or more tiles in operation 811.

FIG. 9 shows an example of data processing system 900 which may be used with one or more embodiments of the present invention. For example and in one embodiment, system 900 may be implemented as a data processing device such as a server system which performs the methods of FIGS. 7-8 or a client system which receives tiles for the map. The data processing system 900 shown in FIG. 9 includes a processing system 911, which may be one or more microprocessors or which may be a system on a chip (integrated circuit) and the system also includes memory 901 for storing data and software programs for execution by the processing system. The memory 901 can store, for example, the software components that implement Algorithms 1-5 described below and memory 901 can be any known form of a machine readable non-transitory storage medium, such as semiconductor memory (e.g., flash; DRAM; SRAM; etc.). The illustrated system 900 also includes an audio input/output subsystem 905.

A display controller and display device 909 can provide a visual user interface for the user; this interface may include a graphical user interface which is similar to that shown on a Macintosh computer when running OS X operating system software or iOS software on an iPhone or iPad. The system 900 also includes one or more wireless transceivers 903 and or wired transceivers (e.g. Ethernet) to communicate with another data processing system. A wireless transceiver may be a WLAN transceiver (e.g. WiFi), an infrared transceiver, a Bluetooth transceiver, and/or a wireless cellular telephony transceiver. It will be appreciated that additional components, not shown, may also be part of the system 900 in certain embodiments, and in certain embodiments fewer components than shown in FIG. 9 may also be used in a data processing system. The system 900 further can include one or more communications ports 917 to communicate with another data processing system. The communications port may be a USB port, Firewire port, Bluetooth interface, a docking port, wired network interface ports (e.g. Ethernet) etc.

The data processing system 900 also includes one or more input devices 913 which are provided to allow a user to provide input to the system. These input devices may be a keypad or a keyboard or a touch panel or a multi-touch panel which is overlaid and integrated with a display device such as display device 909. It will be appreciated that one or more buses, not shown, may be used to interconnect the various components as is well known in the art. The data processing system shown in FIG. 9 may be a server that is part of a server farm; the client devices that receive the tiles for the maps can be a handheld computer or a personal digital assistant (PDA), or a cellular telephone with PDA-like functionality, or a handheld computer which includes a cellular telephone, or a media player, such as an iPod, or a game or entertainment device, or devices which combine aspects or functions of these devices, such as a media player combined with a PDA and a cellular telephone in one device or an embedded device or other consumer electronic devices. In other embodiments, the data processing system 900 may be a network computer or an embedded processing device within another device, or other types of data processing systems which have fewer components or perhaps more components than that shown in FIG. 9.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

A variety of techniques are described below to reduce the tile sizes of vector road networks for efficient transmission and rendering in client devices. As mentioned, reducing the size of the road network data improves network throughput and data load time on a client device (and thus improves the end-user experience). It also makes rendering geometries on client devices more efficient.

The use of vector maps on client devices offer many advantages, including the ability to dynamically transform the same scene into different projections without querying the server, smooth zoom-in and zoom-out functionality, improved placement of metadata such as labels, efficient encoding of topological data and the ability to display the three dimensional real world. Furthermore, vector graphics make maps more interactive and visually pleasing which are important features of touch-enabled devices.

One of the most important parts of vector maps is the road-network data. Each element in the road network consists of large collection of heterogeneous features including, for example, road geometry (sets of coordinate pairs), road class (freeway, highway, etc), labels or road names in several languages, shields/markers, and connectivity, to name a few. The greater the number of such elements included in the road network data, the larger the data size. Additionally, due to the real-world data collection process, each continuous road segment is partitioned into multiple smaller elements, each having its own copy of attributes. The density of such road elements is high in important locations (like urban areas from where majority of client requests are likely to originate). All these factors tend to make the vector road network size very large.

For client-server-based mapping applications on mobile client devices, it is important to transmit and render the road data with minimal glitches. However, the large vector data size may choke the network throughput, resulting in inefficient load times. Additionally, huge vector road data often results in complex geometries which have to be rendered on the client devices, requiring significant processing power and draining the battery.

The embodiments of the invention address these issues using techniques to generate simplified and size-constrained vector road tiles. The Algorithms described below exploit the fixed size of the client viewport (e.g., a fixed, known display size on a mobile client such as an iPhone or iPad) to produce a simplified representation of the road network without any visual difference with representations generated with large input data. Thus, the user experience and interactions are not compromised.

Before proceeding further, the following definitions are relevant to vector mapping applications:

Definition 1. Zoom-Level:

The entire world's geographic data cannot be displayed with any reasonable detail in any device which has a fixed resolution viewport. Hence map data is organized into hierarchical structures, where each level of the hierarchy or “zoom-level” corresponds to particular degree of detail. The deeper one goes into this hierarchy (zoom-in), the more information on the road network one sees. However, the geographic area covered in the viewport to support this zoom-in view decreases.

Definition 2. Vector Tile:

Vector tile is a data structure which contains vector map data. In this invention, we are concerned with road network tiles only. For any given zoom level, the world's mapping information is partitioned into multiple different tiles. Higher zoom levels typically require more tiles to cover the same geographic area.

Before the details of the algorithms, the following are observations on one embodiment of the mapping application:

Observation 1.

Map data is organized in zoom levels. Different degrees of detail will appear in each zoom level. To take advantage of this zoom hierarchy, the roads are categorized into different classes based on their importance (e.g., freeways, highways, major roads, minor roads, etc). Each road class has a unique rendering style. Different road classes show up at different zoom levels. For example, freeways are rendered for the first time at lower zooms than minor roads. Further, various stylistic attributes (shields, labels) show up at different zoom levels.

Observation 2.

The viewport size on devices has fixed size and resolution. At lower zoom levels, a coarse view of the road network (which does not sacrifice too much visual accuracy) is sufficient enough. This does not mean that the embodiments of the invention can only be implemented on one particular client device.

Observation 3.

The real world data collection process breaks up a contiguous road into smaller segments, each having its own copy of heterogenous features (labels in various languages, shields, etc). The only attribute that is different is the actual road geometry. Thus, there exists a lot of redundancy in the mapping data.

Based on the above observations, a road network simplification model is described using algorithms that generate size-constrained road vector tiles without any noticeable visual artifacts. It may be assumed that the vector road network is expressed as a graph G=(V, E), where the edge set is E and vertex set is V. Each unique road segment, e, that has been encoded as a feature is an edge in this graph, e ε E. In one embodiment, an edge can be represented as a line or path between two vertices, and the edge can include a set of meta data such as labels in various languages, shields, geometry, etc. The geometry can define a linear or non-linear path between the two vertices (e.g., the geometry can define an elliptical path or a sinusoidal path between the two vertices). Each junction v (intersecting point of two or more road elements) is represented as a vertex in this graph, v ε V. One embodiment of the invention utilizes a SimplifyRoadNetwork method which includes a set of algorithms, each of which is described in detail in the following sections:

Method SimplifyRoadNetwork(G, θ, δ)

Algorithm 1: U←IdentifyRoadNetworkExtrema(G,θ)

Algorithm 2: H←RemoveDiscontinuitieslnPath(G)

Algorithm 3: J←ChainRoadComponents(H,U)

Algorithm 4: K←MergeSpatiallyProximalPaths(J,δ)

Algorithm 5: P←FindReducedPathCover(K)

In one embodiment, each of these algorithms is performed in sequence on a set of input vector road network data for a given zoom level, and each zoom level is processed separately.

Algorithm 1: IdentifyRoadNetworkExtrema(G, θ).

The goal here is to find the start and end point of all contiguous roads that have same name or shields. By way of example, this may include the start and end junctions of US-101N and US-101S, Main Street, Van Ness, etc. We iterate through all vertices (junctions) in the graph and try to evaluate if a vertex is suitable to be an extrema. Some common cases arise when we have a vertex of degree one or when two edges incident on a vertex have different names. Some uncommon cases arise when a dual carriageway with same name diverges from a single vertex; we evaluate the geometric properties of such vertices (using parameter θ) to infer if it is an extrema.

Algorithm 1 IdentifyRoadNetworkExtrema(G, θ)

1: U ← Ø
2: for all vertex v ε V(G) do
3: if IsExtrema(v, G, θ) then
4: add v to U
5: return U

FIG. 8(b) illustrates a flowchart for identifying road extrema in accordance with one embodiment of the invention. As mentioned, an iteration is performed through all vertices at 812 and the next vertex is selected at 813. At 814, an evaluation is performed to determine whether the vertex is suitable to be used as an extrema. If so, then at 815 it is stored as an extrema in the vector road data. If no, then at 816 is it removed as an extrema from the vector road data. If additional vertices need to be evaluated, determined at 817, then the process loops back to 813 and the next vertex is selected. If not, then the process terminates.

Algorithm 2: RemoveDiscontinuitieslnPath(G).

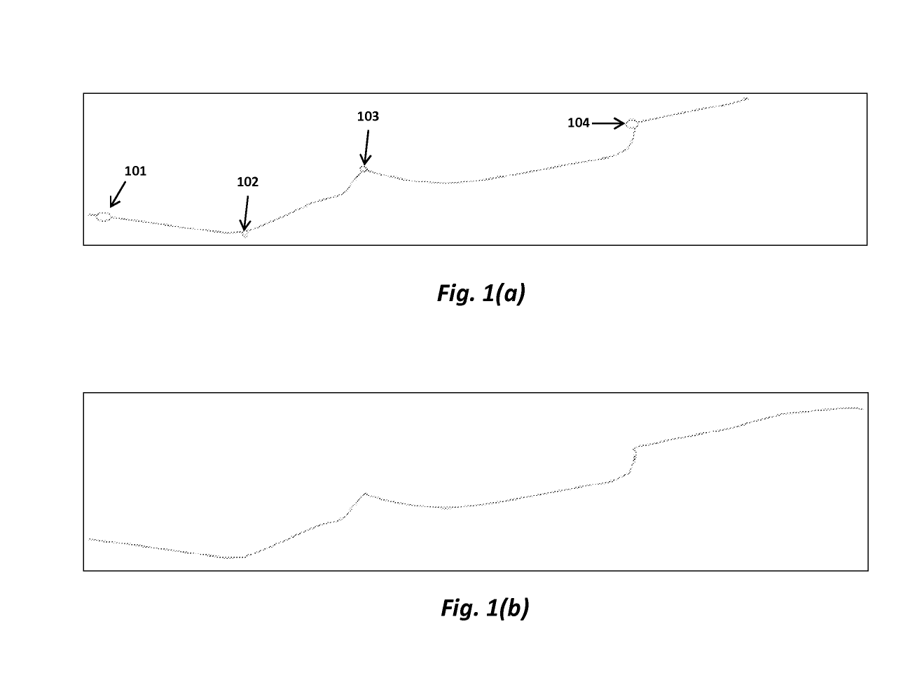

Various minor discontinuities exists in real world. They can be small features (e.g., bridges) or weird geometric shapes (e.g., roundabouts). These discontinuities break contiguous road segments into smaller components that hinder efficient simplification (discussed in the following sections). These discontinuities, being minor in nature, are not perceptible in lower zooms. Hence, they can be removed and replaced in zoom levels below a specified threshold without causing any visual artifacts. FIG. 1(a) shows a set of roundabouts which break a contiguous road segment into smaller components. In one embodiment, these are identified and replaced by linear road elements (e.g., linear edges) as illustrated in FIG. 1(b). In lower zooms, the difference cannot be observed.

Algorithm 2 RemoveDiscontinuitiesInPath(G)

1. H←Ø
2. For all edge e ε E(G) do
3. if IfPartOfDiscontinuity(e, G) then
4. for all edge f ε EdgesInSameDiscontinuity(e, G) do
5. RemoveEdge(f )
6. AddArtificialEdgesToPreserveConnectivity(H)
7. else
8. add e to H
9. return H

FIG. 8(c) illustrates a flowchart for removing discontinuities in accordance with one embodiment of the invention. An iteration is performed through discontinuities at 820 and the next discontinuity is selected at 821. At 822, an evaluation is performed to determine whether the discontinuity is perceptible at the current zoom level. If so, then at 824 it is maintained as part of the vector road data at 824. If not, then at 823, the discontinuity is removed and/or replaced (e.g., with linear road elements such as linear edges as illustrated in FIG. 1(b)). If additional discontinuities need to be evaluated, determined at 825, then the process loops back to 821 and the next discontinuity is selected. If not, then the process terminates.

Algorithm 3: ChainRoadComponents(H, U).

Next, adjacent edges are chained to build paths. Each path P is a contiguous sequence of edges with the same properties. We start from the vertices identified above and traverse the network graph until all edges are covered by at most one path (i.e., an edge is not included in multiple paths). In the end, the algorithm generates a set of paths J, where P ε J.

Algorithm 3 ChainRoadComponents(H,U)

1. J ← Ø
2. for all vertex v ε U do
3. edge list elist ← FindIncidentEdges(v, H)
4. for all edge e ε elist do
5. edge f ← e
6. P←Ø
7. while (f ≠ NULL) do
8. Add f to P
9. f ← FindAdjacentEdge(f,H)
10. Add P to J
11. return J

FIG. 8(d) illustrates a flowchart for chaining road components (e.g., edges) to generate paths. At 830, the network graph is traversed using the vertices (e.g., edges between vertices are identified). At 831, each edge identified in 830 is assigned to a path, ensuring (to limit the data size) that no edge is associated with more than one path. The process then terminates.

Algorithm 4: MergeSpatiallyProximalPaths(J, δ)

Next, spatially proximal paths with the same attributes to a single path are merged. A spatial data structure, a quad tree, is constructed to store the edges in paths. Next, for each edge in a path, an edge is identified which is spatially proximal to it and is not a part of its path. This process is repeated for all edges in this path. At the conclusion, the path which maximally matches the current path is identified and the paths are merged to a single path. This process decreases the size of the road network at least by a size of two.

In the method FindMaxMatchingPath in Algorithm 4 set forth below, a path P and the edges in it are evaluated. Through the SpatiallyProximalEdge method the edges that are the nearest neighbors of every edge in P are found. Then, the paths these nearest neighbors belong to are determined. Thus, for every edge in P, a set of nearest paths are identified. All edges in P are considered together and the paths are ranked based on frequency. Then the highest ranked path is chosen that completely subsumes the current path spatially (so that there are no visible gaps). This path (q) is then returned in the method FindMaxMatchingPath.

The MergePaths(p,q) method can use two approaches: (1) If paths map to same pixel (or pixels which are at a small threshold apart), p or q can be chosen to be their representative; or (2) If not, we choose a centerline between p and q.

Algorithm 4 MergeSpatiallyProximalPaths(J , δ)

1. K←Ø
2. Q←BuildQuadTree(J)
3. for all Path p ε J do
4. edge list elist ← NULL
5. for all Edge e ε p do
6. Edge f ← SpatiallyProximalEdge(e, Q, δ), where f ∉ p
7. elist.insert (f)
8. q = FindMaxMatchingPath(elist)
9. n ← MergePaths(p, q)
10. Add n to K
11. return K

FIG. 8(e) illustrates a flowchart for merging paths to reduce vector road data in accordance with one embodiment of the invention. An iteration is performed through paths at 840 and the next path to be evaluated is selected at 841. At 842, each edge in the path is identified and the nearest neighbor for each edge is identified (i.e., a nearest edge from a different path). At 843, the complete paths for each of the identified nearest neighbors are identified. At 844, the identified paths are merged using the techniques described above. For example, as mentioned, two approaches may be used for merging: (1) If paths map to the same pixel (or pixels which are at a small threshold apart), p or q can be chosen to be their representative; or (2) If not, a centerline between p and q may be chosen. If additional paths need to be evaluated, determined at 845, then the process loops back to 841 and the next path is selected. If not, then the process terminates.

Algorithm 5: FindReducedPathCover(K)

In the final stage, a reduced set of paths is found that cover all edges in the road network. An arbitrary path from the set of paths computed in the previous algorithm is used as a starting point. A “super path” is built by adding this path along with the adjacent paths. Thus, a super path is constructed so that one can traverse between any two junctions in this path by following a linear sequence of edges. The entire road network graph will now be represented by a set of super paths. In one embodiment, every edge will be a member of one and only one super path. This embodiment of the algorithm attempts to find the least number of paths that covers the entire road network and the resulting paths are edge disjoint (meaning there are no common edges between any two paths). In another embodiment, this algorithm can be implemented to allow some redundancy of edges between paths.

Algorithm 5 FindReducedPathCover(K)

1. P ← NULL
2. for all q ε K and q ∉ P do
3. for all r ← AdjacentPath(q, K) and q ∉ P do
4. q ← AggregatePaths(q, r)
5. Add q to P
6. return P

FIG. 8(f) illustrates a flowchart for generating super paths. At 850, the merged paths from the prior operation are identified. At 851, these merged paths are combined to form super paths. As mentioned above, at 851, a super path is constructed so that one can traverse between any two junctions in this path by following a linear sequence of edges and every edge will be a member of one and only one super path. The process then terminates.

Results

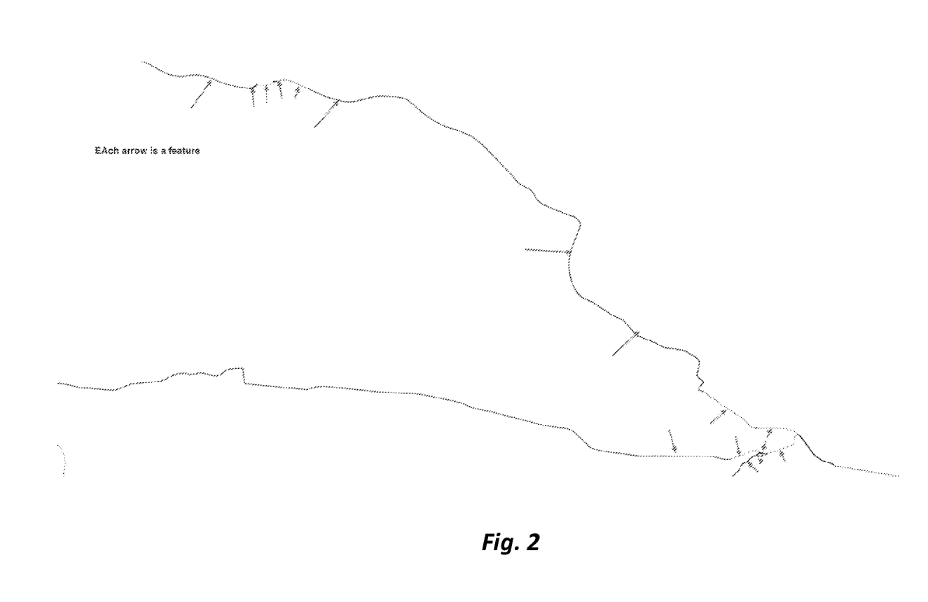

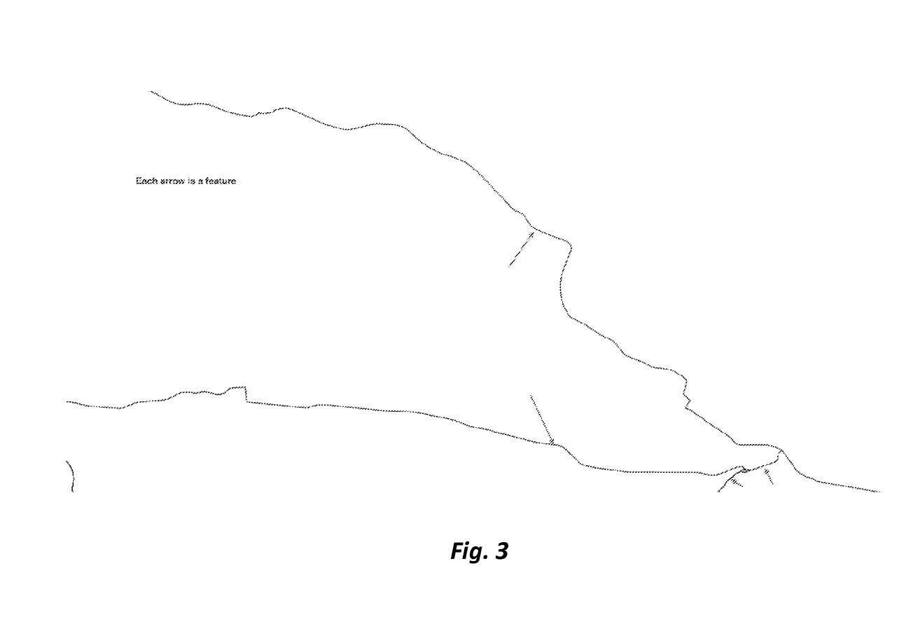

In this section, we present the results of one embodiment of the above algorithms. FIG. 2 illustrates a road network with many discontinuities which are not perceivable at the selected zoom level. They break a road element into smaller segments, increasing the tile size. After using Algorithm 2 (RemoveDiscontinuitiesInPath), the contiguous roads in FIG. 3 are generated.

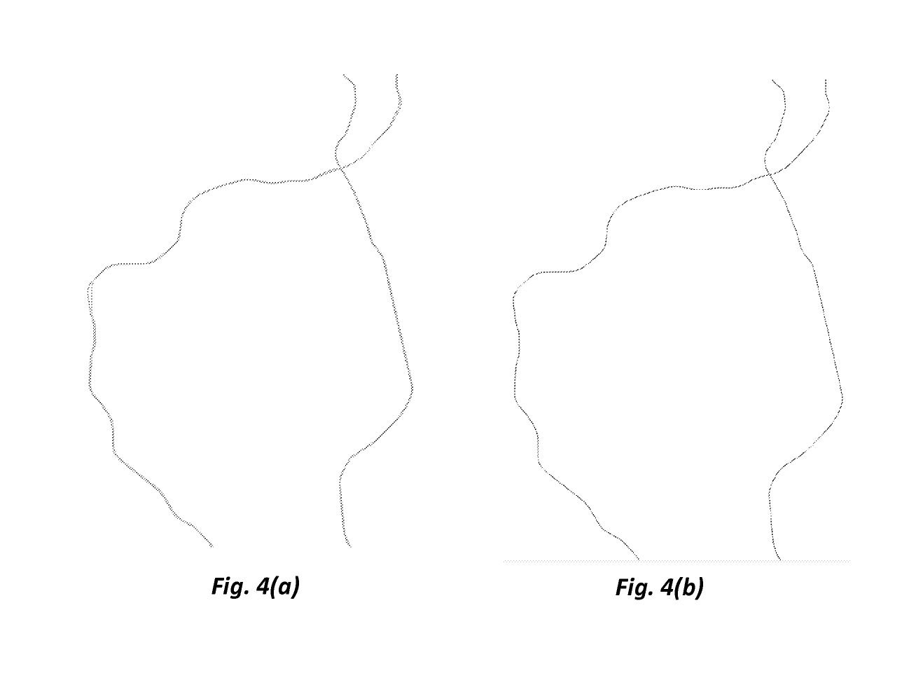

FIG. 4(a) shows a set of freeways before using Algorithm 4 (MergeSpatiallyProximalPaths). FIG. 4(b) shows the same network after using that algorithm.

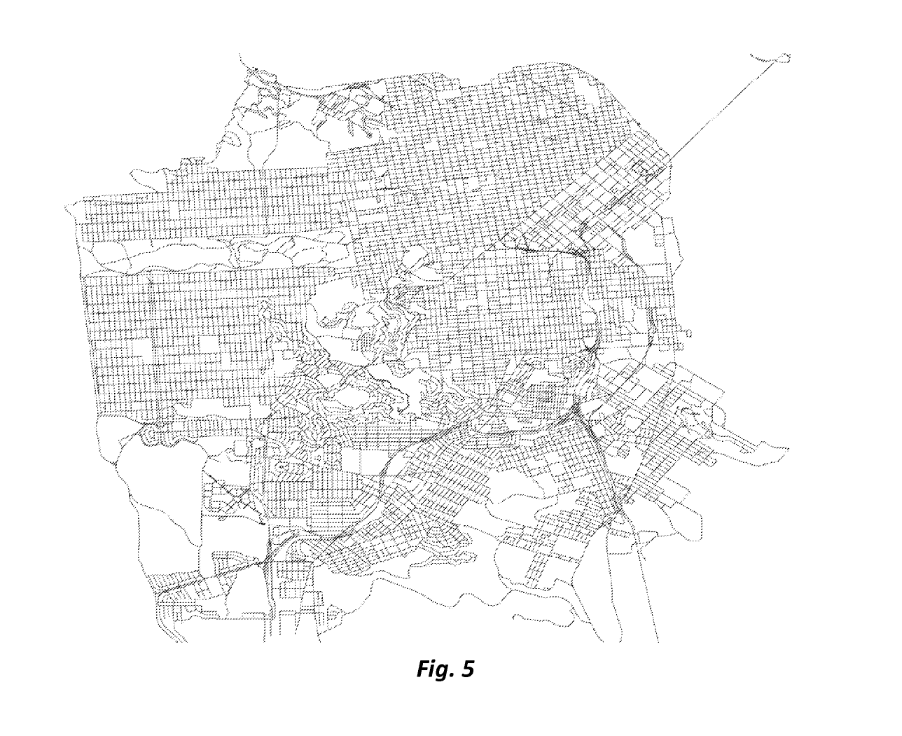

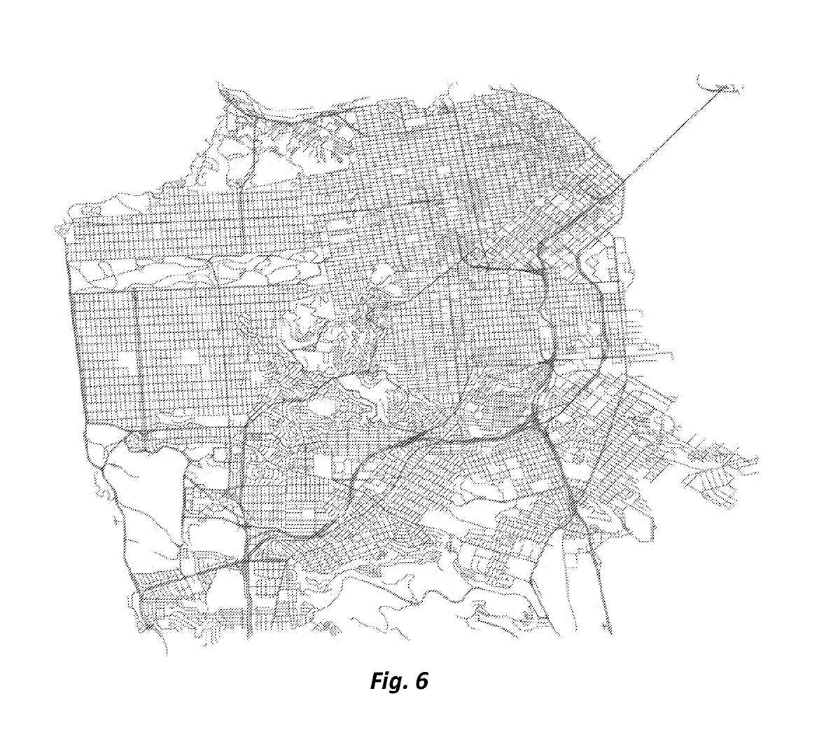

FIG. 5 shows map data of San Francisco before processing through the above algorithms and FIG. 6 shows the map data after being processed by the above algorithms. Although there is almost no visual difference, the tile size reduction was 50% to 80% (depending on geographical areas). This considerably improved the data load time and refresh rates on client devices.

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims below.

Some embodiments include one or more application programming interfaces (APIs) in an environment with calling program code interacting with other program code being called through the one or more interfaces. Various function calls, messages or other types of invocations, which further may include various kinds of parameters, can be transferred via the APIs between the calling program and the code being called. In addition, an API may provide the calling program code the ability to use data types or classes defined in the API and implemented in the called program code.

At least certain embodiments include an environment with a calling software component interacting with a called software component through an API. A method for operating through an API in this environment includes transferring one or more function calls, messages, other types of invocations or parameters via the API.

One or more Application Programming Interfaces (APIs) may be used in some embodiments. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some embodiments the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other embodiments the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program to use the services provided by a Software Development Kit (SDK) library. In other embodiments an application or other client program may use an API provided by an Application Framework. In these embodiments the application or client program may incorporate calls to functions or methods provided by the SDK and provided by the API or use data types or objects defined in the SDK and provided by the API. An Application Framework may in these embodiments provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one embedment, call APIs from different providers such as a set of APIs from an OS provider and another set of APIs from a plug-in provider and another set of APIs from another provider (e.g. the provider of a software library) or creator of the another set of APIs.

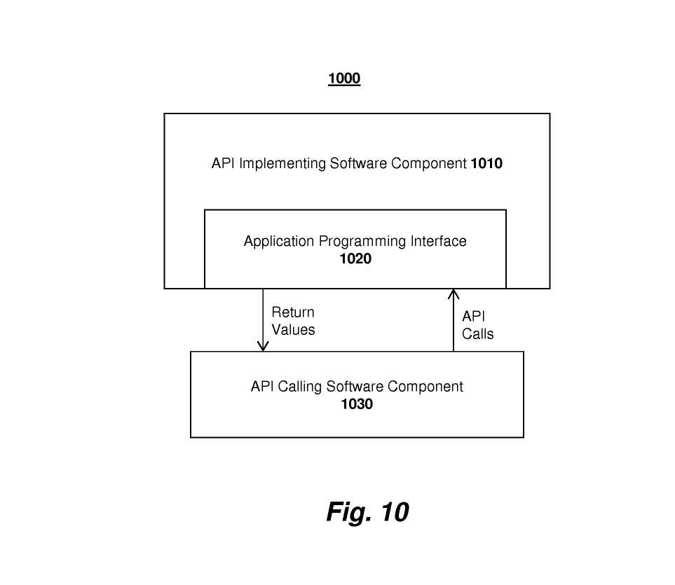

FIG. 10 is a block diagram illustrating an exemplary API architecture, which may be used in some embodiments of the invention. As shown in FIG. 10, the API architecture 1000 includes the API-implementing component 1010 (e.g., an operating system, a library, a device driver, an API, an application program, software or other module) that implements the API 1020. The API 1020 specifies one or more functions, methods, classes, objects, protocols, data structures, formats and/or other features of the API-implementing component that may be used by the API-calling component 1030. The API 1020 can specify at least one calling convention that specifies how a function in the API-implementing component receives parameters from the API-calling component and how the function returns a result to the API-calling component. The API-calling component 1030 (e.g., an operating system, a library, a device driver, an API, an application program, software or other module), makes API calls through the API 1020 to access and use the features of the API-implementing component 1010 that are specified by the API 1020. The API-implementing component 1010 may return a value through the API 1020 to the API-calling component 1030 in response to an API call.

It will be appreciated that the API-implementing component 1010 may include additional functions, methods, classes, data structures, and/or other features that are not specified through the API 1020 and are not available to the API-calling component 1030. It should be understood that the API-calling component 1030 may be on the same system as the API-implementing component 1010 or may be located remotely and accesses the API-implementing component 1010 using the API 1020 over a network. While FIG. 4 illustrates a single API-calling component 1030 interacting with the API 1020, it should be understood that other API-calling components, which may be written in different languages (or the same language) than the API-calling component 1030, may use the API 1020.

The API-implementing component 1010, the API 1020, and the API-calling component 1030 may be stored in a tangible machine-readable storage medium, which includes any mechanism for storing information in a form readable by a machine (e.g., a computer or other data processing system). For example, a tangible machine-readable storage medium includes magnetic disks, optical disks, random access memory (e.g. DRAM); read only memory, flash memory devices, etc.

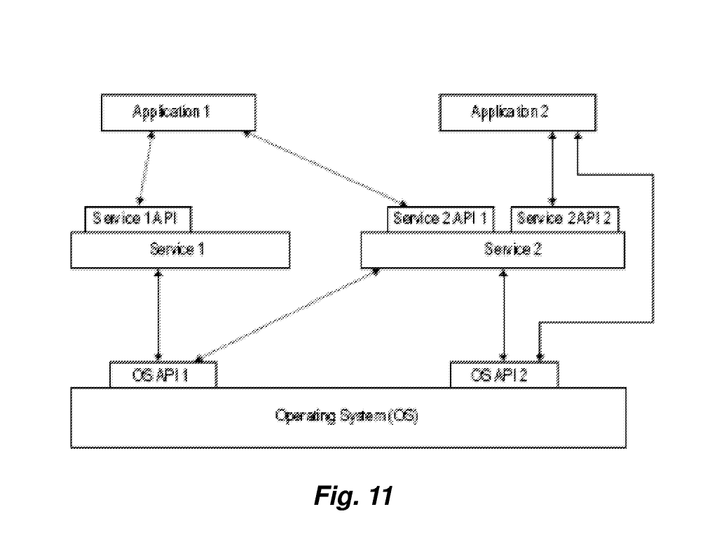

In FIG. 11 (“Software Stack”), an exemplary embodiment, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

Any one of the methods described herein can be implemented on a variety of different data processing devices, including general purpose computer systems, special purpose computer systems, etc. For example, the data processing systems which may use any one of the methods described herein may include a desktop computer or a laptop computer or a tablet computer or a smart phone, or a cellular telephone, or a personal digital assistant (PDA), an embedded electronic device or a consumer electronic device.

What is claimed is:

1. A machine implemented method comprising:
receiving input data comprising a vector road network specifying vertices and edges;
removing discontinuities in paths defined by the vertices and edges;
chaining adjacent edges, the chain reducing the number of vertices and producing a set of paths;
merging spatially proximal paths to create a set of merged paths; and
determining a set of reduced paths from the set of merged paths.

2. The method as in claim 1 wherein removing discontinuities comprises:
determining whether each discontinuity is perceptible at a current zoom level;
keeping the discontinuity if it is perceptible at a current zoom level; and
removing or replacing the discontinuity if it is not perceptible at a current zoom level.

3. The method as in claim 2 wherein replacing the discontinuity comprises replacing the discontinuity with linear road elements.

4. The method as in claim 1 further comprising:
iterating through each vertex to determine whether the vertex may be considered a road network extrema and, if so, then storing the vertex as an extrema in the vector road network.

5. The method as in claim 1 wherein chaining adjacent edges comprises:
traversing the input data using the vectices; and
assigning edges to paths, ensuring that no edge is included in more than one path.

6. The method as in claim 1 wherein merging spatially proximal paths comprises:
identifying a nearest neighbor edge for each edge in a first path, each nearest neighbor edge being associated with a path other than the first path;
for each nearest neighbor edge, identifying its path;
evaluating each path having a nearest neighbor edge in relation to the first path; and
combining the first path with one or more of the other paths having the identified nearest neighbor edges based on the evaluation.

7. The method as in claim 6 wherein evaluating comprises determining if the paths map to the same pixels or pixels which are at a small threshold apart.

8. The method as in claim 6 wherein evaluating comprises choosing a centerline between the first path and the other paths.

9. The method as in claim 1 wherein determining a set of reduced paths comprises:
building a set of super paths from the set of merged paths.

10. The method as in claim 9 wherein building the super paths comprises ensuring that every edge is a member of one and only one super path.

11. The method as in claim 9 wherein building the super paths comprises attempting to find a least number of paths that covers the entire vector road network which are edge disjoint.

12. A non-transitory machine-readable medium having program code stored thereon which, when executed by a machine, causes the machine to perform the operations of:
receiving input data comprising a vector road network specifying vertices and edges;
removing discontinuities in paths defined by the vertices and edges;
chaining adjacent edges, the chain reducing the number of vertices and producing a set of paths;
merging spatially proximal paths to create a set of merged paths; and
determining a set of reduced paths from the set of merged paths.

13. The non-transitory machine-readable medium as in claim 12 wherein removing discontinuities comprises:
determining whether each discontinuity is perceptible at a current zoom level;
keeping the discontinuity if it is perceptible at a current zoom level; and
removing or replacing the discontinuity if it is not perceptible at a current zoom level.

14. The non-transitory machine-readable medium as in claim 13 wherein replacing the discontinuity comprises replacing the discontinuity with linear road elements.

15. The non-transitory machine-readable medium as in claim 12 further comprising:
iterating through each vertex to determine whether the vertex may be considered a road network extrema and, if so, then storing the vertex as an extrema in the vector road network.

16. The non-transitory machine-readable medium as in claim 12 wherein chaining adjacent edges comprises:
traversing the input data using the vectices; and
assigning edges to paths, ensuring that no edge is included in more than one path.

17. The non-transitory machine-readable medium as in claim 12 wherein merging spatially proximal paths comprises:
identifying a nearest neighbor edge for each edge in a first path, each nearest neighbor edge being associated with a path other than the first path;
for each nearest neighbor edge, identifying its path;
evaluating each path having a nearest neighbor edge in relation to the first path; and
combining the first path with one or more of the other paths having the identified nearest neighbor edges based on the evaluation.

18. The non-transitory machine-readable medium as in claim 17 wherein evaluating comprises determining if the paths map to the same pixels or pixels which are at a small threshold apart.

19. The non-transitory machine-readable medium as in claim 17 wherein evaluating comprises choosing a centerline between the first path and the other paths.

20. The non-transitory machine-readable medium as in claim 12 wherein determining a set of reduced paths comprises:
building a set of super paths from the set of merged paths.

21. The non-transitory machine-readable medium as in claim 20 wherein building the super paths comprises ensuring that every edge is a member of one and only one super path.

22. The non-transitory machine-readable medium as in claim 20 wherein building the super paths comprises attempting to find a least number of paths that covers the entire vector road network which are edge disjoint.
